(19) United States
(12) Patent Application Publication
(10) Pub. No.: US 2003/0207175 A1
(43) Pub. Date: Nov. 6, 2003

(54) Active material for electrochemical cell anodes incorporating an additive for precharging/activation thereof

(76) Inventors: Stanford R. Ovshinsky, Bloomfield Hills, MI (US); Srinivasan Venkatesan, Southfield, MI (US); Boyko Aladjov, Rochester Hills, MI (US); Hong Wang, Troy, MI (US); Meera Vijan, West Bloomfield, MI (US); Subhash Dhar, Bloomfield, MI (US)

Correspondence Address: ENERGY CONVERSION DEVICES, INC., 2956 WATERVIEW DRIVE, ROCHESTER HILLS, MI, 48309, US

(21) Appl. No.: 10/436,614

(22) Filed: May 13, 2003

Related U.S. Application Data
(63) Continuation-in-part of application No. 09/999,393, filed on Oct. 31, 2001, now Pat. No. 6,613,471.
Application No. 09/999,393 is a continuation-in-part of application No. 09/524,116, filed on Mar. 13, 2000, now Pat. No. 6,447,942.

(51) Int. Cl. H01M 4/58

(52) U.S. Cl. 429/231.2; 252/182.1

(57) ABSTRACT

A hydrogen storage alloy active material for the negative electrode of an electrochemical cell. The active material includes a hydrogen storage alloy material with a water reactive chemical hydride additive, which, upon utilization of the active material in a negative electrode of an electrochemical cell, gives the negative electrode added benefits, not attainable by using hydrogen storage alloy material alone. These added benefits include 1) precharge of the hydrogen storage material with hydrogen; 2) higher porosity/increased surface area/reduced electrode polarization at high currents; 3) simplified, faster activation of the hydrogen storage alloy; and 4) optionally, enhanced corrosion protection for the hydrogen storage alloy.

### CROSS REFERENCE TO RELATED APPLICATIONS

The present invention is a continuation-in-part of, and is entitled to the benefit of the earlier filing date and priority of, co-pending U.S. patent application Ser. No. 09/999,393, to Ovshinsky et al., which is assigned to the same assignee as the current application, entitled “ACTIVE MATERIAL FOR FUEL CELL ANODES INCORPORATING AN ADDITIVE FOR PRECHARGING/ACTIVATION THEREOF”, filed Oct. 31, 2001, which is a continuation-in-part of U.S. Pat. No. 6,447,942, filed Mar. 13, 2000, which is assigned to the same assignee as the current application, the disclosures of which are hereby incorporated by reference.

### FIELD OF THE INVENTION

The present invention relates to active materials for electrochemical cell negative electrodes, and more specifically, hydrogen storage alloy active materials for the negative electrode of fuel cells and nickel metal hydride batteries. The active material includes a hydrogen storage alloy material with an additive, which, upon utilization of the active material in a negative electrode of an electrochemical cell, gives the negative electrode added benefits, not attainable by using hydrogen storage alloy material alone. These added benefits include 1) precharge of the hydrogen storage material with hydrogen; 2) higher porosity/increased surface area/reduced electrode polarization at high currents; 3) simplified, faster activation of the hydrogen storage alloy; and optionally 4) enhanced corrosion protection for the hydrogen storage alloy. These benefits are achieved by adding a water reactive chemical hydride or other chemical compound capable of releasing hydrogen under certain conditions to the hydrogen storage alloy used as the active material of the negative electrode of an electrochemical cell.

### BACKGROUND OF THE INVENTION

Ni-MH cells and alkaline fuel cells use negative electrodes having a hydrogen absorbing alloy as the active material. The hydrogen absorbing alloy is capable of the reversible electrochemical storage of hydrogen. Ni-MH cells typically use a positive electrode having nickel hydroxide as the active material. The negative and positive electrodes are spaced apart in an alkaline electrolyte such as potassium hydroxide.

Upon application of an electrical current across a NiMH cell, water is dissociated into one hydroxyl ion and one hydrogen ion at the surface of the negative electrode. The hydrogen ion combines with one electron and diffuses into the bulk of the hydrogen storage alloy. This reaction is reversible. Upon discharge, the stored hydrogen is released to form a water molecule and release an electron. This is shown in equation (1):

$$M + {H}_{2} O + {e}^{-} {{⟷}^{charge}}_{discharge} M - H + {OH}^{-} \qquad ( 1 )$$

The negative electrode reactions are reversible. Upon discharge, the stored hydrogen is released from the metal hydride to form a water molecule and release an electron. The reactions that take place at the nickel hydroxide positive electrode of a Ni-MH battery cell are shown in equation (2):

$$Ni {( OH )}_{2} + {OH}^{-} {{⟷}^{charge}}_{discharge} NiOOH + {H}_{2} O + {e}^{-} \qquad ( 2 )$$

The use of disordered metal hydride materials as a negative electrode significantly increases the reversible hydrogen storage capabilities required for efficient and economical electrochemical cell applications, and results in the commercial production of electrochemical cells having high energy density storage, efficient reversibility, high electrical efficiency, bulk hydrogen storage without structural change or poisoning, long cycle life, and deep discharge capability.

Certain hydrogen absorbing alloys, called OVONIC (Trademark of Energy Conversion Devices) alloys, result from tailoring the local chemical order and local structural order by the incorporation of selected modifier elements into a host matrix. Disordered hydrogen absorbing alloys have a substantially increased density of catalytically active sites and storage sites compared to single or multi-phase crystalline materials. These additional sites are responsible for improved efficiency of electrochemical charging/discharging and an increase in electrical energy storage capacity. The nature and number of storage sites can even be designed independently of the catalytically active sites. More specifically, these alloys are tailored to allow bulk storage of the dissociated hydrogen atoms at bonding strengths within the range of reversibility suitable for use in secondary battery applications.

The use of disordered negative electrode metal hydride material significantly increases the reversible hydrogen storage characteristics required for efficient and economical battery applications, and results in the commercial production of batteries having high energy density storage, efficient reversibility, high electrical efficiency, bulk hydrogen storage without structural change or poisoning, long cycle life, and deep discharge capability.

Some extremely efficient electrochemical hydrogen storage alloys were formulated, based on the disordered materials described above. These are the Ti—V—Zr—Ni type active materials such as disclosed in U.S. Pat. No. 4,551,400 (“the '400 patent”) the disclosure of which is incorporated herein by reference. These materials reversibly form hydrides in order to store hydrogen. All the materials used in the '400 patent utilize a generic Ti—V—Ni composition, where at least Ti, V, and Ni are present and may be modified with Cr, Zr, and Al. The materials of the '400 patent are multiphase materials, which may contain, but are not limited to, one or more phases with C₁₄ and C₁₅ type crystal structures.

Other Ti—V—Zr—Ni alloys, also used for rechargeable hydrogen storage negative electrodes, are described in U.S. Pat. No. 4,728,586 (“the '586 patent”), the contents of which is incorporated herein by reference. The '586 patent describes a specific sub-class of Ti—V—Ni—Zr alloys comprising Ti, V, Zr, Ni, and a fifth component, Cr. The '586 patent, mentions the possibility of additives and modifiers beyond the Ti, V, Zr, Ni, and Cr components of the alloys, and generally discusses specific additives and modifiers, the amounts and interactions of these modifiers, and the particular benefits that could be expected from them. Other hydrogen absorbing alloy materials are discussed in U.S. Pat. Nos. 5,096,667, 5,135,589, 5,277,999, 5,238,756, 5,407,761, and 5,536,591, the contents of which are incorporated herein by reference.

An important step in the proper operation of a nickel metal hydride battery involves activation or forming of the negative electrodes. Conventional gas phase activation of any hydride former is accomplished by repeatedly absorbing and desorbing hydrogen under pressure. In using the OVONIC (Trademark of Energy Conversion Devices) alloys in nickel metal hydride batteries, this cannot be done by the conventional method because the cells are positioned in an aqueous medium. By being positioned in the aqueous medium, the gas phase absorption/desorption of hydrogen may not take place. Besides these cells are not designed to stand high pressures or temperatures. Alternatively, a thermal “heat soak” or an electrochemical (current/potential) pulsing can be used as a method of activating the electrodes forcing accelerated hydrogen absorption/desorption. This pulsing involves quick bursts of electrochemical charging and discharging for several cycles. While this procedure works, it involves a fair amount of time to accomplish the desired level of activation.

There are a few options to accelerate the activation of the electrodes and to improve their electrochemical performance. They are: 1) pre-hydride the powders before making the electrodes; 2) pre-hydride the electrodes; and 3) externally charge the electrodes electrochemically and assemble the cell. These options are not practical because: 1) pre-hydrided powders cannot be handled safely and are also susceptible to oxidation; 2) pre-hydrided electrodes will lose their integrity in the prehydriding chambers and are also highly susceptible to oxidation; and 3) externally charged electrodes will have both sides exposed to electrolyte thus compromising the integrity of the hydrophobic sealing layer. It is also difficult to prevent the electrodes from oxidizing. Thus there is a need in the art for an improved, fast, and practical method of precharging/activating the electrode with hydrogen and electrode materials for performing such precharging/activation.

### SUMMARY OF THE INVENTION

The present invention is a hydrogen storage alloy active material for the negative electrode of an electrochemical cell. The active material includes a hydrogen storage alloy material with an additive, which, upon utilization of the active material in a negative electrode of an electrochemical cell, gives the negative electrode added benefits, not attainable by using hydrogen storage alloy material alone. These added benefits include 1) precharge of the hydrogen storage material with hydrogen; 2) increase the number of hydrogen catalytic sites per unit area; 3) higher porosity/increased surface area/reduced electrode polarization at high currents; 4) simplified, faster activation of the hydrogen storage alloy; and 5) optionally, enhanced corrosion protection for the hydrogen storage alloy. These benefits are achieved by adding a water reactive chemical hydride or chemical compound capable of releasing hydrogen under certain conditions to the hydrogen storage alloy used as part of the active material of the negative electrode of an electrochemical cell.

A typical example of such a chemical hydride is sodium borohydride (alkali borohydrides). Other chemical hydrides, such as alkali and alkaline earth metal hydrides may be used. Examples of such hydrides are LiAl hydrides (LiAlH₆), KH, NaH, and CaNi₅H₆. All of these chemical hydrides will serve the same basic purpose. The chemical hydrides are chosen such that their stability can be altered under certain conditions, such as in the presence of water, to produce hydrogen. Preferably the chemical hydride is stable in air. The chemical hydride should be selected such that its reaction byproduct with water (electrolyte) minimally has no deleterious effect on the electrochemical cell operation and may be selected such that its byproduct has a beneficial effect (such as corrosion inhibition) on the electrochemical cell. In any event, the byproduct should at least be inert to the main electrochemical reactions taking place within the electrochemical cell.

### BRIEF DESCRIPTION OF THE DRAWINGS

FIG. 1, shows a comparison between the activation times of a negative electrode in accordance with the present invention versus a standard metal hydride negative electrode.

FIG. 2, shows a comparison between the resistance of negative electrodes in accordance with the present invention versus a standard metal hydride negative electrode.

### DETAILED DESCRIPTION OF THE INVENTION

The present invention is a hydrogen storage alloy active material for the negative electrode of an electrochemical cell such as a fuel cell or battery. The active material includes a hydrogen storage alloy material with an additive, which, upon utilization of the active material in a negative electrode of an electrochemical cell, gives the negative electrode added benefits, not attainable by using hydrogen storage alloy material alone. These added benefits include 1) precharge of the hydrogen storage material with hydrogen; 2) increase the number of hydrogen catalytic sites per unit area; 3) higher porosity/increased surface area/reduced electrode polarization at high currents; 4) simplified, faster activation of the hydrogen storage alloy; and 5) optionally, enhanced corrosion protection for the hydrogen storage alloy. These benefits are achieved by adding a water reactive chemical hydride and/or chemical compound capable of releasing hydrogen under certain conditions to the hydrogen storage alloy used as the active material of the negative electrode of the electrochemical cell.

The active material for the negative electrode generally comprises 0.1 to 10.0 weight percent of a water reactive chemical hydride and 90.0 to 99.9 weight percent of a hydrogen storage alloy. The active material may further comprise up to 2 weight percent of a binder material as needed to preserve the integrity of the electrode before and during use.

Usually, the water reactive chemical hydride, upon exposure to water (in the alkaline electrolyte), reacts to form atomic hydrogen and a reaction byproduct. If this reaction were to take place in the absence of a hydrogen storage alloy, the atomic hydrogen released will recombine to form molecular hydrogen and escape. One example of such a water reactive hydride is sodium borohydride (NaBH₄). When exposed to water the sodium borohydride reacts with the water to form sodium borate and release hydrogen. Since the chemical hydride is in intimate contact with the hydrogen storage alloy, this atomic hydrogen is quickly adsorbed into the hydrogen storage alloy where it is stored in the form of a hydride. The formulas for this reaction are as follows:

NaBH₄+2H₂O---->NaBO₂+4H₂; and

M+½H₂---->M-H

Thus, the reaction of the water reactive hydride with the water in the electrolyte of an electrochemical cell creates hydrogen which is adsorbed into the hydrogen storage alloy of the electrode, thereby precharging the alloy with hydrogen, thus increasing the electrodes electrochemical performance.

Initially, metal hydride particles are intentionally partially oxidized during the manufacturing process in order to enable their safe and proper handling during electrode preparation steps. The activation technique generally reacts with the oxide layer, converting it into a porous form, thereby exposing the underlying hydrogen catalytic centers making them easily available for electrochemical reaction. By adding a water reactive chemical hydride and/or a compound capable of releasing hydrogen under certain conditions, the number of hydrogen catalytic centers available for electrochemical reaction are increased thus increasing the electrochemical performance of the resulting electrochemical cell.

In addition to precharging the hydrogen storage alloy, the reaction of the chemical hydride with the water creates additional porosity in the active material of the electrode. That is, when the chemical hydride reacts with water to produce hydrogen, the hydrogen is immediately adsorbed into the hydrogen storage alloy and additional porosity is formed. Also, if the reaction byproduct is soluble in the aqueous electrolyte, even more porosity is formed. Choosing and varying the right chemical compound could alter the overall electrode porosity in a controllable way. Thus in the reaction above, the reaction of sodium borohydride with water forms hydrogen, which, is immediately absorbed by the hydrogen storage alloy. The removal of sodium borohydride (and its subsequent decomposition) leaves behind voids which become fresh pores.

This increase in porosity of the active material of the negative electrode of the electrochemical cell enhances the electrochemical performance of the electrode. The increased porosity increases the effective surface area of the electrode, thereby decreasing the actual current density of the electrode. This decrease in current density, in turn, leads to a decrease in polarization of the electrode. Polarization, put simply, is the loss of electrode potential, at conditions different from equilibrium, wherein a higher applied current gives rise to a higher overall loss due to the electrode polarization phenomena.

In addition to the precharging and reduced polarization benefits described herein above, another added benefit from the water reactive chemical hydride additive is that of electrode activation. This is advantageous as the negative electrodes require some activation. Typically negative electrodes are activated by either 1) immersing the active hydrogen storage material or the electrodes produced therefrom in a concentrated aqueous solution of potassium hydroxide at elevated temperatures (heat soaking); or 2) in-situ activation of the electrodes in the electrochemical cell by electrochemical charge/discharge cycling in the presence of the aqueous potassium hydroxide electrolyte. While these techniques work for activating the negative electrodes, the activation in some cases (depending on the alloy composition) is very slow. Thus, the addition of the water reactive chemical hydride additive speeds up and enhances the activation of the negative electrode. This activation assistance may be used in conjunction with the electrochemical activation of the negative electrode to further enhance its electrochemical performance and to completely activate the negative electrodes in shorter period of time using fewer charge/discharge pulse cycles. As mentioned above, the activation process changes the hydrogen storage alloy negative electrode from its as-produced state by 1) breakup and dissolution of the soluble species of oxides at the surface of the alloy particles, as well as 2) cracking of the alloy particles, thereby exposing fresh, un-oxidized catalytic surfaces.

Another, optional, benefit from using the water reactive chemical hydride additive is that of corrosion inhibition. That is, the reaction byproduct of some chemical hydrides may provide the nickel metal hydride negative electrodes with corrosion inhibition. This is true of the sodium borate byproduct of the sodium borohydride additive. While not all chemical hydride byproducts will necessarily produce this result, it is an added optional benefit to be considered when selecting the chemical hydride additive to be used.

It should be noted that, in addition to sodium borohydride, other chemical hydrides, such as alkali and alkaline earth metal hydrides may be used. Examples of such hydrides are LiAl hydrides (LiAlH₆), KH, NaH, and CaNi₅H₆. All of these chemical hydrides will serve the same basic purpose. The chemical hydrides are chosen such that they are unstable under certain conditions, such as in the presence of water, and react therewith to produce hydrogen. Preferably the chemical hydride is stable in air. In the case of CaNi₅H₆, the decomposition thereof in the presence of water will not only serve to precharge the negative electrode, but will also leave behind a thin layer of nickel film which will act as an additional catalyst and conductivity enhancer. The chemical hydride should be selected such that its reaction byproduct with water minimally has no deleterious effect on the electrochemical cell operation and may be selected such that its byproduct has a beneficial effect (such as corrosion inhibition) on the electrochemical cell.

While a specific hydrogen storage alloy is described herein above, the hydrogen storage alloy active material is any hydrogen storage alloy which can reversibly absorb and release hydrogen irrespective of the hydrogen storage capacity and has the properties of a fast hydrogenation reaction rate, a good stability in the electrolyte and a long shelf-life. It should be noted that, by hydrogen storage capacity, it is meant that the material stores hydrogen in a stable form, in some nonzero amount higher than trace amounts. Preferred materials will store about 0.1 weight % hydrogen or more. Preferably, the alloys include, for example, rare-earth/Misch metal based alloys, zirconium and/or titanium based alloys or mixtures thereof. The negative electrode material may even be layered such that the material on the hydrogen input surface is formed from a material which has been specifically designed to be highly catalytic to the dissociation of molecular hydrogen into atomic hydrogen, while the material on electrolyte interface surface is designed to be highly catalytic to the formation of water from hydrogen and hydroxyl ions.

Certain hydrogen storage materials are exceptionally useful as negative electrode materials. The useful hydrogen storage alloys have excellent catalytic activity for the formation of hydrogen ions from molecular hydrogen and also have superior catalytic activity toward the formation of water from hydrogen ions and hydroxyl ions. In addition to having exceptional catalytic capabilities, the materials also have outstanding corrosion resistance toward the alkaline electrolyte contained within electrochemical cells.

Specific alloys useful as the negative electrode material are alloys that contain enriched catalytic nickel regions of 50-70 Angstroms in diameter distributed throughout the oxide interface which vary in proximity from 2-300 Angstroms preferably 50-100 Angstroms, from region to region. As a result of these nickel regions, the materials exhibit significant catalysis and conductivity. The density of Ni regions in the alloy of the '591 patent provides powder particles having an enriched Ni surface. The most preferred alloys having enriched Ni regions are alloys having the following composition:

(Base Alloy)ₐCo_{b}Mn_{c}Fe_{d}Snₑ

where the Base Alloy comprises 0.1 to 60 atomic percent Ti, 0.1 to 40 atomic percent Zr, 0 to 60 atomic percent V, 0.1 to 57 atomic percent Ni, and 0 to 56 atomic percent Cr; b is 0 to 7.5 atomic percent; c is 13 to 17 atomic percent; d is 0 to 3.5 atomic percent; e is 0 to 1.5 atomic percent; and a+b+c+d+e=100 atomic percent.

The binder materials may be any material, which binds the active material together to prevent degradation of the electrode during its lifetime. Binder materials should be resistant to the conditions present within the electrochemical cells. Examples of additional binder materials, which may be added to the active composition, include, but are not limited to, polymeric binders such as polyvinal alcohol (PVA), carboxymethyl cellulose (CMC) and hydroxycarboxymethyl cellulose (HCMC). Other examples of polymeric binders include fluoropolymers. An example of a fluoropolymer is polytetrafluoroethylene (PTFE). Other examples of additional binder materials, which may be added to the active composition, include elastomeric polymers such as styrene-butadiene. In addition, depending upon the application, additional hydrophobic materials may be added to the active composition.

### EXAMPLE 1

A battery negative electrode in accordance with the present invention was formed and tested against a standard metal hydride battery negative electrode. The standard metal hydride electrode was formed by roll compacting a standard metal hydride powder onto an expanded nickel mesh substrate. The negative electrode in accordance with the present invention was formed by roll compacting a mixture of 1 weight percent sodium borohydride and 99 weight percent of a standard metal hydride powder onto an expanded nickel mesh substrate.

The activation times of the negative electrodes were measured using a positive limited tri-electrode battery cell (test battery cell) formed using one of the formed hydrogen storage alloy negative electrodes, a nickel hydroxide positive electrode and an auxiliary Hg/HgO reference electrode. Each one of these electrodes are contained in a non conducting but porous separator bag to prevent shorting. The nickel hydroxide positive electrode includes an active electrode composition formed by physically mixing 88.6 weight percent nickel hydroxide material with co-precipitated zinc and cobalt from Tanaka Chemical Company, 5.0 weight percent cobalt, 6.0 weight percent cobalt oxide, and 0.4 weight percent polyvinyl alcohol binder. The active electrode composition is made into a paste and applied onto a nickel foam substrate/current collector to form the nickel hydroxide positive electrode.

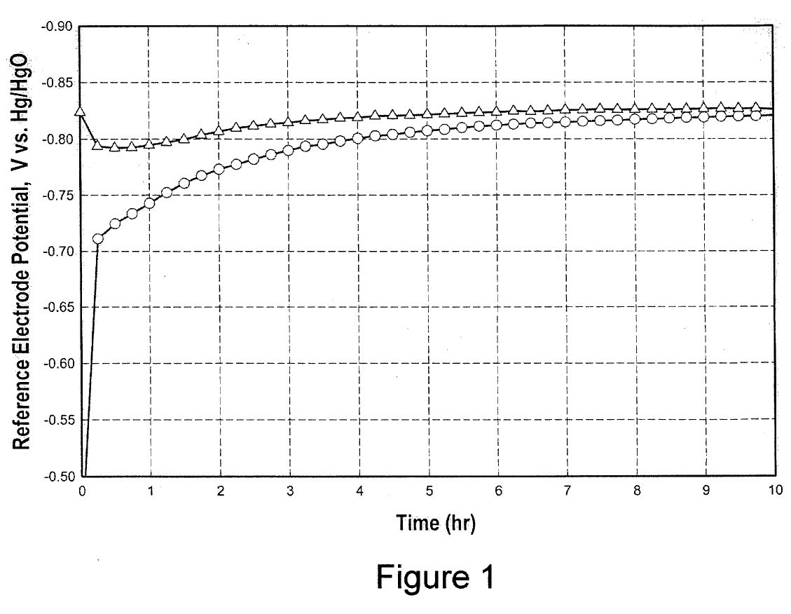

The negative electrode containing 1.0 weight percent sodium borohydride (Δ) showed a reduced activation time as compared to the standard metal hydride negative electrode (∘). Immediately upon testing, based upon the measured equilibrium potentials, the negative electrode containing 1.0 weight percent sodium borohydride became activated whereas the standard misch metal negative electrode reached the same activation level only after more than 10 hours. These results are shown in FIG. 1.

### EXAMPLE 2

A battery negative electrode in accordance with the present invention was formed and tested against a standard metal hydride battery negative electrode. The standard metal hydride electrode was formed by roll compacting a standard metal hydride powder onto an expanded nickel mesh substrate. The negative electrode in accordance with the present invention was formed by roll compacting a mixture of 2.0 weight percent sodium borohydride and 98 weight percent of a standard metal hydride powder onto an expanded nickel mesh substrate.

The charge/discharge performance of the negative electrodes were measured using a positive limited tri-electrode battery cell (test battery cell) formed using one of the formed hydrogen storage alloy negative electrodes, a nickel hydroxide positive electrode counter electrode, and an auxiliary Hg/HgO reference electrode. Each one of these electrodes are contained in a non conducting but porous separator bag to prevent shorting. The nickel hydroxide positive electrode includes an active electrode composition formed by physically mixing 88.6 weight percent nickel hydroxide material with co-precipitated zinc and cobalt from Tanaka Chemical Company, 5.0 weight percent cobalt, 6.0 weight percent cobalt oxide, and 0.4 weight percent polyvinyl alcohol binder. The active electrode composition is made into a paste and applied onto a nickel foam substrate/current collector to form the nickel hydroxide positive electrode.

The discharge current of the standard metal hydride negative electrode and the negative electrode containing 2.0 weight percent sodium borohydride were tested by a scanning current technique, where the potential of the test electrode was measured at an aplied constant current scan rate of 5 mA/sec. The results are shown below in Table 1. At a cut-off electrode potential of −0.8 V, the negative electrode containing 2.0 weight percent sodium borohydride showed a 10.6% improvement over the standard metal hydride negative electrode in respect to achieved current density, and at a cut-off electrode potential of −0.75 V, the negative electrode containing 2.0 weight percent sodium borohydride showed a 8.99% improvement over the standard metal hydride negative electrode.

TABLE 1

| Negative | | | | |
|---|---|---|---|---|
| Electrode | Control | | | |
| Potential, | Cell | Test Cell | | |
| V vs. | Discharge | Discharge | | |
| Hg/HgO | Current | Current | | |
| reference | Density, | Density, | | |
| electrode | mA/cm² | mA/cm² | Difference | % Improvement |
| 0.80 | 233.043 | 257.809 | 24.766 | 10.6 |
| 0.75 | 247.528 | 269.796 | 22.268 | 8.99 |

### EXAMPLE 3

Two battery negative electrodes in accordance with the present invention was formed and tested against a standard metal hydride battery negative electrode to compare the internal resistance of the electrodes. The standard metal hydride electrode was formed by roll compacting a standard metal hydride powder onto an expanded nickel mesh substrate. The negative electrodes in accordance with the present invention were formed by roll compacting a mixture of 1.0 weight percent sodium borohydride and 99 weight percent of a standard metal hydride powder onto an expanded nickel mesh substrate and a mixture of 2.0 weight percent sodium borohydride and 98 weight percent of a standard metal hydride powder onto a second expanded nickel mesh substrate.

A negative electrode limited tri-electrode battery cell (test battery cell) is formed using a hydrogen storage alloy negative electrode, a nickel hydroxide positive electrode and an auxiliary Hg/HgO reference electrode. The nickel hydroxide positive electrode includes an active electrode composition formed by physically mixing 88.6 weight percent nickel hydroxide material with co-precipitated zinc and cobalt from Tanaka Chemical Company, 5.0 weight percent cobalt, 6.0 weight percent cobalt oxide, and 0.4 weight percent polyvinyl alcohol binder. The active electrode composition is made into a paste and applied onto a conductive nickel foam to form the positive electrode.

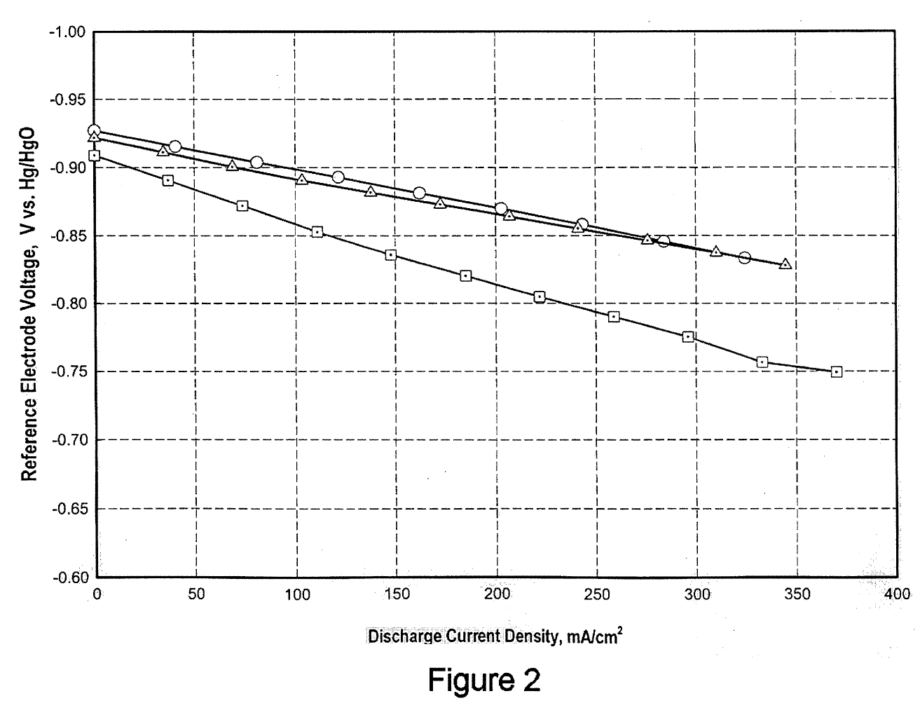

After the initial formation procedure and two regular charge/discharge cycles, the control cell (utilizing standard positive negative electrode) and the test cells (utilizing negative electrodes with sodium borohydride) are each discharged to 50% depth of discharge at constant discharge current. The control cell and the test cells are then subjected to a sequence of 10 second discharge pulses of increasing magnitude (0.5 amp, 1 amp, 1.5 amp, etc.). The potential of the positive electrode after 10 sec. is measured relative to the Hg/HgO reference electrode. The potential values (at the end of each of the discharge current pulses) were plotted versus the value of the discharge currents for both the control cell and the test cells. The slopes of the linear portion of the plots represents the resistance of each negative electrode. The electrodes containing the sodium borohydride (1%-∘, 2%-Δ) showed reduced resistance as compared to the standard metal hydride negative electrode (□) tested under the same conditions. The measurements for the tri-electrode test are shown in FIG. 2, and the results for these tests are shown in Table 2.

TABLE 2

| | Resistance at the end of |
|---|---|
| Sample | a 10 Second Pulse |
| Standard Negative Electrode | .028 Ohm |
| Negative Electrode w/ 1.0 wt % NaBH₄ | .017 Ohm |
| Negative Electrode w/ 2.0 wt % NaBH₄ | .017 Ohm |

The drawings, discussion, descriptions, and examples of this specification are merely illustrative of particular embodiments of the invention and are not meant as limitations upon its practice. It is the appended claims, including all equivalents, that define the scope of the invention.

1. An active material for an electrochemical cell negative electrode, said active material comprising:
a hydrogen storage alloy; and
a water reactive chemical hydride intimately mixed with said hydrogen storage alloy.

2. The active material of claim 1, wherein said water reactive chemical hydride is selected from the group consisting of hydrides or borohydrides of alkali metals, alkaline earth metals and alloys thereof.

3. The active material of claim 2, wherein said water reactive chemical hydride is sodium borohydride.

4. The active material of claim 2, wherein said water reactive chemical hydride is potassium hydride.

5. The active material of claim 2, wherein said water reactive chemical hydride is sodium hydride.

6. The active material of claim 1, wherein said water reactive chemical hydride is lithium aluminum hydride.

7. The active material of claim 1, wherein said water reactive chemical hydride is calcium nickel hydride.

8. The active material of claim 1, wherein said hydrogen storage alloy is selected from the group consisting of rare-earth/Misch metal alloys, zirconium alloys, titanium alloys, and mixtures or alloys thereof.

9. The active material of claim 8, wherein said hydrogen storage alloy has the following composition:
(Base Alloy)ₐCo_{b}Mn_{c}Fe_{d}Snₑ
where the Base Alloy comprises 0.1 to 60 atomic percent Ti, 0.1 to 40 atomic percent Zr, 0 to 60 atomic percent V, 0.1 to 57 atomic percent Ni, and 0 to 56 atomic percent Cr; b is 0 to 7.5 atomic percent; c is 13 to 17 atomic percent; d is 0 to 3.5 atomic percent; e is 0 to 1.5 atomic percent; and a+b+c+d+e=100 atomic percent.

10. The active material of claim 8, wherein said hydrogen storage alloy has the following composition, in atomic percent: 10.5% La, 4.3% Ce, 0.5 Pr, 1.4% Nd, 60.0% Ni, 12.7% Co, 5.9% Mn and 4.7% Al.

11. A battery negative electrode comprising:
a hydrogen storage alloy; and
a water reactive chemical hydride intimately mixed with said hydrogen storage alloy.

12. The battery negative electrode of claim 11, wherein said water reactive chemical hydride is selected from the group consisting of hydrides or borohydrides of alkali metals, alkaline earth metals and alloys thereof.

13. The battery negative electrode of claim 12, wherein said water reactive chemical hydride is sodium borohydride.

14. The battery negative electrode of claim 12, wherein said water reactive chemical hydride is potassium hydride.

15. The battery negative electrode of claim 12, wherein said water reactive chemical hydride is sodium hydride.

16. The battery negative electrode of claim 11, wherein said water reactive chemical hydride is lithium aluminum hydride.

17. The battery negative electrode of claim 11, wherein said water reactive chemical hydride is calcium nickel hydride.

18. The battery negative electrode of claim 11, wherein said hydrogen storage alloy is selected from the group consisting of rare-earth/Misch metal alloys, zirconium alloys, titanium alloys, and mixtures or alloys thereof.

19. The battery negative electrode of claim 18, wherein said hydrogen storage alloy has the following composition:
(Base Alloy)ₐCo_{b}Mn_{c}Fe_{d}Snₑ
where the Base Alloy comprises 0.1 to 60 atomic percent Ti, 0.1 to 40 atomic percent Zr, 0 to 60 atomic percent V, 0.1 to 57 atomic percent Ni, and 0 to 56 atomic percent Cr; b is 0 to 7.5 atomic percent; c is 13 to 17 atomic percent; d is 0 to 3.5 atomic percent; e is 0 to 1.5 atomic percent; and a+b+c+d+e=100 atomic percent.

20. The battery negative electrode of claim 18, wherein said hydrogen storage alloy has the following composition, in atomic percent: 10.5% La, 4.3% Ce, 0.5 Pr, 1.4% Nd, 60.0% Ni, 12.7% Co, 5.9% Mn and 4.7% Al.
